(19) United States
(12) Patent Application Publication
(10) Pub. No.: US 2009/0115406 A1
(43) Pub. Date: May 7, 2009

(54) SYSTEM AND METHOD FOR MINIMIZING MUTUAL INDUCTANCE COUPLING BETWEEN COILS IN AN ELECTROMAGNETIC TRACKING SYSTEM

(75) Inventors: Peter Traneus Anderson, Andover, MA (US); Gerald Lee Beauregard, Stratham, NH (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/933,609

(22) Filed: Nov. 1, 2007

(51) Int. Cl. G01B 7/14

(52) U.S. Cl. 324/207.17

(57) ABSTRACT

A system and method of minimizing the mutual inductance coupling between two or more coils of a coil array of an electromagnetic tracking system. The system involves a geometric arrangement of two or more coils, which significantly reduces any mutual inductance coupling between the two or more coils. The method involves characterization of two or more coils and compensating for mutual inductance coupling between the characterized two or more coils.

### BACKGROUND OF THE INVENTION

This disclosure relates generally to an electromagnetic tracking system that uses electromagnetic fields to determine the position and orientation of an object, and more particularly to a system and method for minimizing the mutual inductance coupling between coils in an electromagnetic tracking system.

Electromagnetic tracking systems have been used in various industries and applications to provide position and orientation information relating to objects. For example, electromagnetic tracking systems may be useful in aviation applications, motion sensing applications, retail applications, and medical applications. In medical applications, electromagnetic tracking systems have been used to provide an operator (e.g., a physician, surgeon, or other medical practitioner) with information to assist in the precise and rapid positioning of a medical device or instrument located in or near a patient's body during image-guided surgery. An electromagnetic tracking system provides positioning and orientation information for a medical device or instrument with respect to the patient or a reference coordinate system. An electromagnetic tracking system provides intraoperative tracking of the precise location of a medical device or instrument in relation to multidimensional images of a patient's anatomy.

An electromagnetic tracking system uses visualization tools to provide a medical practitioner with co-registered views of a graphical representation of the medical device or instrument with pre-operative or intraoperative images of the patient's anatomy. In other words, an electromagnetic tracking system allows a medical practitioner to visualize the patient's anatomy and track the position and orientation of a medical device or instrument with respect to the patient's anatomy. As the medical device or instrument is positioned with respect to the patient's anatomy, the displayed image is continuously updated to reflect the real-time position and orientation of the medical device or instrument. The combination of the image and the representation of the tracked medical device or instrument provide position and orientation information that allows a medical practitioner to manipulate a medical device or instrument to a desired location with an accurate position and orientation.

Generally, electromagnetic tracking systems include electromagnetic transmitters and electromagnetic receivers with at least one coil or a coil array. An alternating drive current signal is provided to each coil in the electromagnetic transmitter, generating an electromagnetic field being emitted from each coil of the electromagnetic transmitter. The electromagnetic field generated by each coil in the electromagnetic transmitter induce a voltage in each coil of the electromagnetic receiver. These voltages are indicative of the mutual inductances between the coils of the electromagnetic transmitter and the coils of the electromagnetic receiver. These voltages and mutual inductances are sent to a computer for processing. The computer uses these measured voltages and mutual inductances to calculate the position and orientation of the coils of the electromagnetic transmitter relative to the coils of the electromagnetic receiver, or the coils of the electromagnetic receiver relative to the coils of the electromagnetic transmitter, including six degrees of freedom (x, y, and z measurements, as well as roll, pitch and yaw angles).

Preferably, the mutual inductances between coils of the electromagnetic transmitter and the electromagnetic receiver may be measured without inaccuracies. However, electromagnetic tracking systems are known to suffer from accuracy degradation due to electromagnetic field distortion caused by the presence of an uncharacterized metal distorter within the tracking volume or electromagnetic fields of the electromagnetic tracking system. The presence of an uncharacterized metal distorter within the tracking volume of the electromagnetic tracking system may create distortion of the electromagnetic fields of the electromagnetic tracking system. This distortion may cause inaccuracies in tracking the position and orientation of medical devices and instruments by causing inaccuracies in position and orientation calculations of the coils of the electromagnetic transmitter relative to the coils of the electromagnetic receiver, or the coils of the electromagnetic receiver relative to the coils of the electromagnetic transmitter.

As an additional consideration, electromagnetic tracking systems may be limited by the number of degrees of freedom they are able to track. In general, the number of degrees of freedom that an electromagnetic tracking system is able to track and resolve depends on the number of transmitting and receiving coils in the system. For example, a system comprising a single transmitting coil and multiple receiver coils may track a device or instrument in only five degrees of freedom (x, y, and z coordinates, as well as pitch and yaw angles). The roll angle is not measurable. As will be appreciated, the magnetic field from a coil small enough to be approximated as a dipole is symmetrical about the axis of the coil (coil's roll axis). As a result, rotating the coil about the coil's axis (i.e., the degree of freedom commonly known as “roll”) does not change the magnetic field. The processor performing the processing cannot resolve the rotational orientation (roll) of the coil. Consequently, only five degrees of freedom of position and orientation are trackable.

One approach of obtaining the roll angle measurement is to add another coil to the electromagnetic transmitter or electromagnetic receiver configuration. However, having two coils in close proximity introduces “mutual inductance coupling” into the mix. Mutual inductance coupling between coils can negatively impact accuracy performance of an electromagnetic tracking system because cross-coupling currents cannot be accurately measured. Mutual inductance coupling between the two coils permits the current in one coil to induce a voltage in the second coil, causing current flow in the second coil with the first coil's waveform. This unwanted current makes distinguishing the two coils' magnetic fields more difficult.

Therefore, there is a need for a system and method of minimizing the mutual inductance coupling between coils in an electromagnetic tracking system.

### BRIEF DESCRIPTION OF THE INVENTION

In an embodiment, an electromagnetic tracking system comprising at least one transmitter assembly with at least two transmitter coils, the at least two transmitter coils spaced apart from each other and positioned to minimize the mutual inductance coupling between the at least two transmitter coils; at least one receiver assembly with at least one receiver coil, the at least one receiver assembly communicating with and receiving signals from the at least two coils of the at least one transmitter assembly; and electronics coupled to and communicating with the at least one transmitter assembly and the at least one receiver assembly for calculating the position and orientation of an object to be tracked.

In an embodiment, a method of minimizing mutual inductance coupling between coils in an electromagnetic tracking system, the method comprising arranging at least two coils of a transmitter assembly in a fixed arrangement, wherein the at least two coils are spaced apart from each other and angled at a fixed angle with respect to a longitudinal axis extending through the at least two coils; applying a drive signal to each coil of the at least two coils of the transmitter assembly to generate a magnetic field from each coil; tracking each coil of the at least two coils of the transmitter assembly independently as single coils with a receiver assembly and electronics for determining positions of the at least two coils; and using the tracked positions and known fixed arrangement of the at least two coils for determining orientations of the at least two coils.

In an embodiment, a system for minimizing mutual inductance coupling between coils in an electromagnetic tracking system, the system comprising at least one electromagnetic transmitter assembly with at least two coils, the at least two coils of the at least one transmitter assembly are spaced apart from each other and angled at a fixed angle with respect to a longitudinal axis extending through the at least two coils; at least one electromagnetic receiver assembly with at least one coil; drive circuitry for each coil of the at least two coils of the at least one electromagnetic transmitter assembly capable of providing a drive current to each coil for energizing each coil and having each coil generate a magnetic field that is detectable by at least one coil of the at least one electromagnetic receiver assembly; open circuit circuitry for each coil of the at least two coils of the at least one electromagnetic transmitter assembly capable of creating an open circuit for each coil and ensuring no current flows through an open circuited coil; and electronics coupled to and communicating with the at least one transmitter assembly and the at least one receiver assembly for calculating the position and orientation of an object to be tracked; wherein the at least one electromagnetic transmitter assembly is mounted to a mounting fixture to hold the at least one electromagnetic transmitter assembly mechanically fixed relative to the at least one electromagnetic receiver assembly.

In an embodiment, a method of improving the tracking of an electromagnetic tracking system, the method comprising calibrating a particular transmitter assembly comprising two or more single coils by determining the inherent mutual inductance coupling between the two or more single coils; producing a mathematical representation of the inherent mutual inductance coupling between the two or more single coils of the particular transmitter assembly and storing the produced mathematical representation in association with that particular transmitter assembly; tracking the position and orientation of the particular transmitter assembly; and adjusting the tracked position and orientation of the particular transmitter assembly to compensate for any errors caused by the inherent mutual inductance coupling between the two or more single coils of the particular transmitter assembly.

Various other features, objects, and advantages of the invention will be made apparent to those skilled in the art from the accompanying drawings and detailed description thereof.

### BRIEF DESCRIPTION OF THE DRAWINGS

FIG. 1 is a block diagram illustrating an exemplary embodiment of an electromagnetic tracking system;

FIG. 2 is a schematic diagram illustrating an exemplary embodiment of an electromagnetic transmitter or receiver coil arrangement for an electromagnetic tracking system;

FIG. 3 is a flow diagram illustrating an exemplary embodiment of a method of minimizing mutual inductance coupling between coils in an electromagnetic tracking system;

FIG. 4 is a block diagram illustrating an exemplary embodiment of a system for minimizing mutual inductance coupling between coils in an electromagnetic tracking system; and

FIG. 5 is a flow diagram illustrating an exemplary embodiment of a method of minimizing mutual inductance coupling between coils in an electromagnetic tracking system.

### DETAILED DESCRIPTION OF THE INVENTION

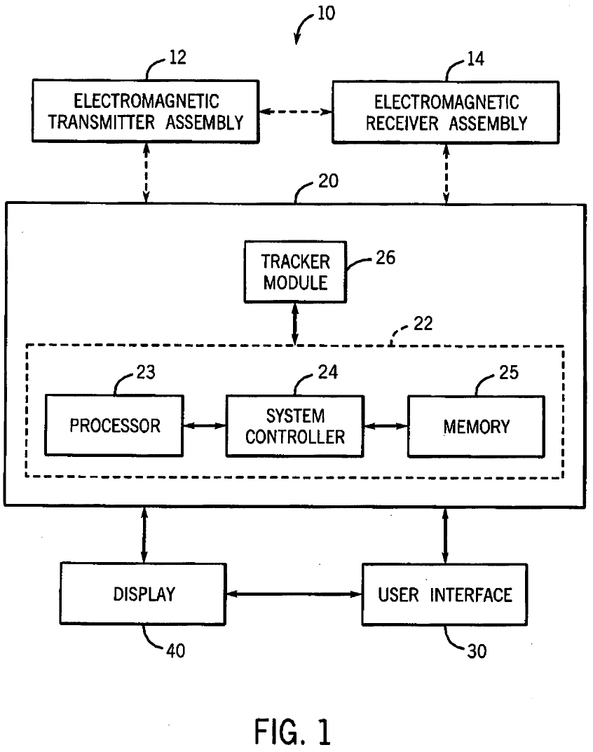

Referring now to the drawings, FIG. 1 is a block diagram illustrating an exemplary embodiment of an electromagnetic tracking system 10. The electromagnetic tracking system 10 comprises at least one electromagnetic transmitter assembly 12 with two or more coils and at least one electromagnetic receiver assembly 14 with two or more coils. The at least one electromagnetic transmitter assembly 12 with two or more coils is configured to minimize the mutual inductance coupling between the two or more coils.

The electromagnetic tracking system 10 further comprises a tracker workstation 20 coupled to and receiving data from the at least one electromagnetic transmitter assembly 12 and the at least one electromagnetic receiver assembly 14, a user interface 30 coupled to the tracker workstation 20, and a display 40 for visualizing imaging and tracking data. The tracker workstation 20 includes a tracking system computer 22 and a tracker module 26. The tracking system computer 22 includes at least one processor 23, a system controller 24 and memory 25.

The two or more coils of the at least one electromagnetic transmitter and receiver assemblies 12, 14 may be built with various coil architectures. Industry standard coil architecture (ISCA) type coils are defined as three approximately collocated, approximately orthogonal, and approximately dipole coils. Therefore, an ISCA electromagnetic tracking system would include three approximately collocated, approximately orthogonal, and approximately dipole coils for the transmitter and three approximately collocated, approximately orthogonal, and approximately dipole coils for the receiver. In other words, an ISCA configuration includes a three-axis dipole coil transmitter and a three-axis dipole coil receiver. In the ISCA configuration, the transmitter coils and receiver coils are configured such that the three coils (i.e., coil trios) exhibit the same effective area, are oriented orthogonally to one another, and are centered at the same point. Using this configuration, parameter measurements may be obtained (i.e., a measurement between each transmitting coil and each receiving coil). From the parameter measurements, processing may determine position and orientation information for each coil of the transmitter with respect to each coil of the receiver, or vice versa. If either of the transmitter assembly or receiver assembly is in a known position, processing may also resolve position and orientation information relative to the known position.

In an exemplary embodiment, the two or more coils of the at least one electromagnetic transmitter assembly 12 may be characterized as single dipole coils and emit magnetic fields when a current is passed through the coils. Those skilled in the art will appreciate that multiple transmitting coils may be used in coordination to generate multiple magnetic fields. Similar to the at least one electromagnetic transmitter assembly 12, the two or more coils of the at least one electromagnetic receiver assembly 14 may be characterized as single dipole coils and detect the magnetic fields emitted by the at least one electromagnetic transmitter assembly 12. When a current is applied to the coils of the at least one electromagnetic transmitter assembly 12, the magnetic fields generated by the coils may induce a voltage into each coil of the at least one electromagnetic receiver assembly 14. The induced voltage is indicative of the mutual inductance between the two or more coils of the at least one electromagnetic transmitter assembly 12. Thus, the induced voltage across each coil of the at least one electromagnetic receiver assembly 14 is detected and processed to determine the mutual inductance between each coil of the at least one electromagnetic transmitter assembly 12 and each coil of the at least one electromagnetic receiver assembly 14.

The magnetic field measurements may be used to calculate the position and orientation of the at least one electromagnetic transmitter assembly 12 with respect to the at least one electromagnetic receiver assembly 14, or vice versa according to any suitable method or system. The detected magnetic field measurements are digitized by electronics that may be included with the at least one electromagnetic receiver assembly 14 or the tracker module 26. The magnetic field measurements or digitized signals may be transmitted from the at least one electromagnetic receiver assembly 14 to the tracking system computer 22 using wired or wireless communication protocols and interfaces. The digitized signals received by the tracking system computer 22 represent magnetic field information detected by the at least one electromagnetic receiver assembly 14. The digitized signals are used to calculate position and orientation information of the at least one electromagnetic transmitter assembly 12 or the at least one electromagnetic receiver array 14.

The position and orientation information is used to register the location of the at least one electromagnetic receiver assembly 14 or the at least one electromagnetic transmitter assembly 12 to acquired imaging data from an imaging system. The position and orientation data is visualized on the display 40, showing in real-time the location of the at least one electromagnetic transmitter assembly 12 or the at least one electromagnetic receiver assembly 14 on pre-acquired or real-time images from the imaging system. The acquired imaging data may be from a computed tomography (CT) imaging system, a magnetic resonance (MR) imaging system, a positron emission tomography (PET) imaging system, an ultrasound imaging system, an X-ray imaging system, or any suitable combination thereof. All six degrees of freedom (three of position (x, y, z) and three of orientation (roll, pitch, yaw)) of the at least one electromagnetic receiver assembly 14 or the at least one electromagnetic transmitter assembly 12 may be determined and tracked.

In an exemplary embodiment, the coils of the at least one electromagnetic transmitter and receiver assemblies 12, 14 are either precisely manufactured or precisely characterized during manufacture to obtain mathematical models of the coils in the at least one electromagnetic transmitter and receiver assemblies 12, 14. From the magnetic field measurements and mathematical models of the coils, the position and orientation of the at least one electromagnetic receiver assembly 14 with respect to the at least one electromagnetic transmitter assembly 12 may be determined. Alternatively, the position and orientation of the at least one electromagnetic transmitter assembly 12 with respect to the at least one electromagnetic receiver assembly 14 may be determined.

In an exemplary embodiment, the at least one electromagnetic transmitter assembly 12 may be a battery-powered wireless transmitter assembly, a passive transmitter assembly, or a wired transmitter assembly. In an exemplary embodiment, the at least one electromagnetic receiver assembly 14 may be a battery-powered wireless receiver assembly, a passive receiver assembly, or a wired receiver assembly.

In an exemplary embodiment, the at least one electromagnetic transmitter assembly 12 may be attached to a medical device or instrument to be tracked and the at least one electromagnetic receiver assembly 14 may be positioned within the at least one electromagnetic field generated by the at least one electromagnetic transmitter assembly 12.

In an exemplary embodiment, the at least one electromagnetic receiver assembly 14 may be attached to a medical device or instrument to be tracked and the at least one electromagnetic transmitter assembly 12 may be positioned to generate at least one electromagnetic field receivable by the at least one electromagnetic receiver assembly 14.

In an exemplary embodiment, the tracker module 26 may include drive circuitry configured to provide a drive current to each coil of the at least one electromagnetic transmitter assembly 12. In an exemplary embodiment, the drive circuitry may be included on the at least one electromagnetic transmitter assembly 12. By way of example, a drive current may be supplied by the drive circuitry to energize a coil of the at least one electromagnetic transmitter assembly 12, and thereby generate an electromagnetic field that is detected by a coil of the at least one electromagnetic receiver assembly 14. The drive current may be comprised of a periodic waveform with a given frequency (e.g., a sine wave, cosine wave or other periodic signal). The drive current supplied to a coil will generate an electromagnetic field at the same frequency as the drive current. The electromagnetic field generated by a coil of the at least one electromagnetic transmitter assembly 12 induces a voltage indicative of the mutual inductance in a coil of the at least one electromagnetic receiver assembly 14. In an exemplary embodiment, the tracker module 26 may include receiver data acquisition circuitry for receiving voltage and mutual inductance data from the at least one electromagnetic receiver assembly 14. In an exemplary embodiment, the receiver data acquisition circuitry may be included on the at least one electromagnetic receiver assembly 14.

In an exemplary embodiment, the two or more coils of the at least one electromagnetic transmitter assembly 12 may be supplied with sine wave signals operating at different frequencies, above the power line frequencies of 50 to 60 Hz. In an exemplary embodiment, the sine wave signals may be at frequencies between 8 kHz and 40 kHz, thus, generating magnetic fields at frequencies between 8 kHz and 40 kHz.

In an exemplary embodiment, the tracking system computer 22 may include at least one processor 23, such as a digital signal processor, a CPU, or the like. The processor 23 may process measured voltage and mutual inductance data from the at least one electromagnetic receiver assembly 14 to track the position and orientation of the at least one electromagnetic transmitter assembly 12 or the at least one electromagnetic receiver assembly 14.

The at least one processor 23 may implement any suitable algorithm(s) to use the measured voltage signal indicative of the mutual inductance to calculate the position and orientation of the at least one electromagnetic receiver assembly 14 relative to the at least one electromagnetic transmitter assembly 12, or the at least one electromagnetic transmitter assembly 12 relative to the at least one electromagnetic receiver assembly 14. For example, the at least one processor 23 may use ratios of mutual inductance between each coil of the at least one electromagnetic receiver assembly 14 and each coil of the at least one electromagnetic transmitter assembly 12 to triangulate the relative positions of the coils. The at least one processor 23 may then use these relative positions to calculate the position and orientation of the at least one electromagnetic transmitter assembly 12 or the at least one electromagnetic receiver assembly 14.

In an exemplary embodiment, the tracking system computer 22 may include a system controller 24. The system controller 24 may control operations of the electromagnetic tracking system 10.

In an exemplary embodiment, the tracking system computer 22 may include memory 25, which may be any processor-readable media that is accessible by the components of the tracker workstation 20. In an exemplary embodiment, the memory 25 may be either volatile or non-volatile media. In an exemplary embodiment, the memory 25 may be either removable or non-removable media. Examples of processor-readable media may include (by way of example and not limitation): RAM (Random Access Memory), ROM (Read Only Memory), registers, cache, flash memory, storage devices, memory sticks, floppy disks, hard drives, CD-ROM, DVD-ROM, network storage, and the like.

In an exemplary embodiment, the user interface 30 may include devices to facilitate the exchange of data and workflow between the system and the user. In an exemplary embodiment, the user interface 30 may include a keyboard, a mouse, a joystick, buttons, a touch screen display, or other devices providing user-selectable options, for example. In an exemplary embodiment, the user interface 30 may also include a printer or other peripheral devices.

In an exemplary embodiment, the display 40 may be used for visualizing the position and orientation of a tracked object with respect to a processed image from an imaging system.

Notwithstanding the description of the exemplary embodiment of the electromagnetic tracking system 10 illustrated FIG. 1, alternative system architectures may be substituted without departing from the scope of the invention.

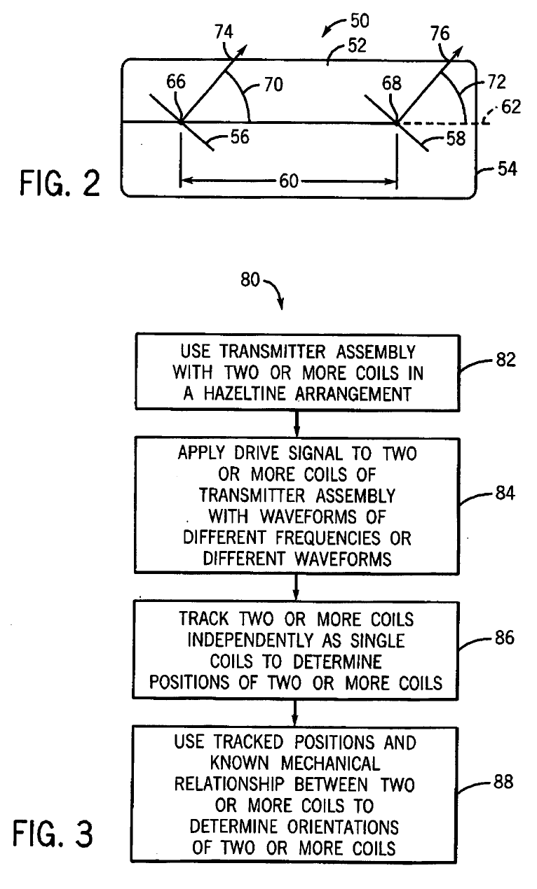

FIG. 2 is a schematic diagram illustrating an exemplary embodiment of an electromagnetic transmitter or receiver coil arrangement 50 for an electromagnetic tracking system. The electromagnetic transmitter coil arrangement 50 includes an electromagnetic transmitter coil array 52 enclosed within a housing 54. The transmitter coil array 52 includes a first transmitter coil 56 and a second transmitter coil 58 that are spaced apart from each other by a separation distance 60. The housing 54 provides for rigidly mounting the first transmitter coil 56 and the second transmitter coil 58. The housing 54 may take the form of an enclosure coupled to the body of a device or instrument. The first transmitter coil 56 and a second transmitter coil 58 are configured in a distinctive geometric arrangement relative to each other to minimize the mutual inductance coupling between the first transmitter coil 56 and the second transmitter coil 58, and allows all six degrees of freedom (x, y, z, roll, pitch, yaw) to be tracked.

In this geometric arrangement, the first transmitter coil 56 and a second transmitter coil 58 are angled to minimize the mutual inductance between the two coils. In an exemplary embodiment, the first transmitter coil 56 and a second transmitter coil 58 are at approximately 54.7 degrees with respect to a horizontal axis 62 extending through the centers 66, 68 of the two coils. The first transmitter coil 56 and the second transmitter coil 58 are angled at the same orientation relative to the horizontal axis 62 running from the center 66 of the first transmitter coil 56 to the center 68 of the second transmitter coil 58. For example, the first transmitter coil 56 may be angled at an angle 70 from the horizontal axis 62. The second transmitter coil 58 may be angled at the same angle 72 from the horizontal axis 62. In the illustrated exemplary embodiment, the first transmitter coil 56 and the second transmitter coil 58 may have a first magnitude vector 74 and a second magnitude vector 76, respectively, when drive currents are supplied to the coils.

As mentioned above, the geometric arrangement of the coils minimizes the mutual inductance coupling between the coils, so that each coil passes current at just its own frequency and/or waveform. Because of this arrangement, the two transmitter coils are tracked independently as coils, so the positions of the first transmitter coil and the second transmitter coil may be tracked.

Each of the two transmitter coils is supplied with different current waveforms. In an exemplary embodiment, the two coils are driven at different frequencies and/or different waveforms. For example, each transmitter coil may be driven by a sine wave, but at different frequencies. In an exemplary embodiment, the first transmitter coil 54 is supplied with a first drive signal at a first frequency and the second transmitter coil 56 is supplied with a second drive signal at a second frequency. The two transmitter coils are operated at different frequencies so that their magnetic fields may be distinguished. The two frequencies are above the power line frequencies of 50 to 60 Hz. Alternatively, each transmitter coil may be driven by different waveforms at the same frequency or at different frequencies. In an exemplary embodiment, the first transmitter coil 54 is supplied with a sine wave and the second transmitter coil 56 is supplied with a cosine wave. The different drive signals permit distinguishing the magnetic fields from the two transmitter coils 54, 56.

Processing may be employed to track each coil. To accomplish this, processing may need to distinguish each of the magnetic fields sensed by the at least one receiver coil array. Drive currents are supplied to each of the first coil and the second coil. For example, each drive current may include an identifying characteristic to allow processing to distinguish which coil of the transmitter is generating each of the sensed magnetic fields. In an exemplary embodiment, providing a current to induce a magnetic field may include driving both the first coil and the second coil at the same frequency, but out of phase. For example, the first coil may be driven by a sine waveform current and the second coil may be driven by a cosine waveform current. In this embodiment, the two current waveforms may have the same frequency with a phase offset of approximately ninety degrees.

As will be appreciated by those skilled in the art, the waveforms driving the first coil and the second coil may include a phase offset that is not ninety degrees, but is suitable to allow processing to differentiate between the generated waveforms.

Although offsetting the phases of the waveforms provided to each coil of the transmitter may provide for distinguishing the first coil and the second coil, to aid in processing it may be necessary to provide an additional distinguishing characteristic to each of the respective waveforms. This may be accomplished by increasing or decreasing the strength of the magnetic fields relative to one another. The strength of the magnetic field may be characterized by the magnitude of the magnetic field moment vector. The magnitude of the magnetic field moment vector may be increased or decreased by varying the amplitude of the drive current waveform. For example, the first coil may be driven by a current waveform with a first amplitude and the second coil may be driven by a current waveform of a second amplitude. In an exemplary embodiment, the ratio of the first magnitude vector to the second magnitude vector could be used to distinguish the two magnetic fields and, thus, allow processing to distinguish the first coil and the second coil.

As will be appreciated by those skilled in the art, the ratio of the magnitude vectors may be varied to accommodate specific applications. For example, a larger ratio may be desirable in a system configured to detect and process signals of significantly different magnitudes or a smaller ratio may be desired for a system configured to detect and process signals of similar magnitudes.

In an exemplary embodiment, if the transmitter coil array 52 is wireless, then the first transmitter coil and the second transmitter coil are driven by self-contained circuitry and power source. With such a wireless implementation, the phases of the coils' sine waves are tracked and are subjected to a 180-degree ambiguity. This has the effect that each tracked orientation vector may or may not be multiplied by −1. Equivalently, one may say that the signs of the gains of the coils are not known.

The mechanical asymmetry of the arrangement of the two transmitter coils permits a determination of these signs. One may use the tracked positions and the known mechanical relationship between the two coils to calculate expected orientation vectors of the two coils. These two estimated orientation vectors will individually be approximately the same as or approximately opposite-direction to the tracked orientation vectors. Reverse the direction of the tracked orientations vectors as needed to make the tracked orientation vectors agree with the expected orientation vectors.

FIG. 3 is a flow diagram illustrating an exemplary embodiment of a method 80 of minimizing mutual inductance coupling between coils in an electromagnetic tracking system. The method 80 describes an exemplary embodiment for calculating the position and orientation of a transmitter assembly or a receiver assembly that may be attached to a medical device, implant or instrument using the electromagnetic tracking system 10 illustrated in FIG. 1 and the electromagnetic transmitter coil arrangement 50 illustrated in FIG. 2. Furthermore, this method 80 may be performed by computer software, hardware, firmware, or any combination thereof.

The method 80 may be implemented with a transmitter assembly having two or more coils in a Hazeltine arrangement at step 82. A Hazeltine arrangement is defined as two or more coils being separated from each other by a separation distance and being angled at approximately 54.7 degrees with respect to a horizontal axis extending through the centers of the two or more coils. At step 84, a drive signal is applied to the two or more coils of the transmitter assembly with waveforms of different frequencies or different waveforms. The two or more coils of the transmitter assembly may be tracked independently as single coils to determine the positions of the two or more coils at step 86. At step 88, the tracked positions and known mechanical relationship between the two or more coils of the transmitter assembly are used to determine the orientations of the two or more coils of the transmitter assembly.

An algorithm to determine orientation quaternions of both coils (including roll information unavailable from tracking either coil singly) as discussed in method 80 follows.

The tracked position and orientation vectors may be defined as:
P₁=position vector of the first coil; and
O₁=orientation vector of the first coil;
P₂=position vector of the second coil; and
O₂=orientation vector of the second coil.

The position vector of a coil points to the coil's position in space. The orientation vector of a coil points in the same direction as the coil's axis. The length of the orientation vector is usually made to be unity.

The vector from the second coil to the first coil may be defined as:

V₂₁=P₁−P₂

The Cartesian coordinates of each coil, including roll, may be expressed as a set of three orthogonal unit vectors. A set of three orthogonal unit vectors for the first coil (Xhat_first, Yhat_first, Zhat_first) may be constructed using knowledge of V₂₁.

V₂₁ points in the assembly-housing +X direction, so a unit vector in the assembly housing +X direction may be:

Xhat_housing=V₂₁/|V₂₁|

This unit vector is the same for both the first and second coils.

The +X orientation unit vector for the first coil may be:

Xhat_first=Xhat_housing

A vector in the +Z direction for the first coil may be:

Zfirst=O₁.cross.Xhat_first/O₁.dot.Xhat_first

where .cross. represents the vector cross product, and .dot. represents the vector dot product.

This works because vector O₁ is far from parallel to vector V₂₁ and O₁ is far from perpendicular to vector V₂₁.

The denominator makes the result independent of the sign of the coil gain. If the coil mechanical angle is approximately −54.7 degrees rather than approximately +54.7 degrees, then multiply Zfirst by −1.

The +Z orientation unit vector for the first coil may be:

Zhat_first=Zfirst/|Zfirst|

The +Y orientation unit vector for the first coil may be:

Yhat_first=Zhat_first .cross. Xhat_first

The three unit vectors Xhat_first, Yhat_first, Zhat_first may be assembled into a 3×3 matrix to obtain the orthonormal rotation matrix representing the orientation of the first transmitter coil. An algorithm may be used to convert the matrix to determine the first receiver coil orientation quaternion.

The same calculations as discussed above may be used for the second transmitter coil.

The +X orientation unit vector for the second coil may be:

Xhat_second=Xhat_housing

A vector in the +Z direction for the second coil may be:

Zsecond=O₂.cross.Xhat/O₂.dot.Xhat

where .cross. represents the vector cross product, and .dot. represents the vector dot product.

The denominator makes the result independent of the sign of the coil gain. If the coil mechanical angle is approximately −54.7 degrees rather than approximately +54.7 degrees, then multiply Zsecond by −1.

The +Z orientation unit vector for the second coil may be:

Zhat_second=Zsecond/|Zsecond|

The +Y orientation unit vector for the second coil may be:

Yhat_second=Zhat_second .cross. Xhat_second

The three unit vectors Xhat_second, Yhat_second, Zhat_second may be assembled into a 3×3 matrix, to obtain the orthonormal rotation matrix representing the orientation of the second coil. An algorithm may be used to convert the matrix to determine the second receiver coil orientation quaternion.

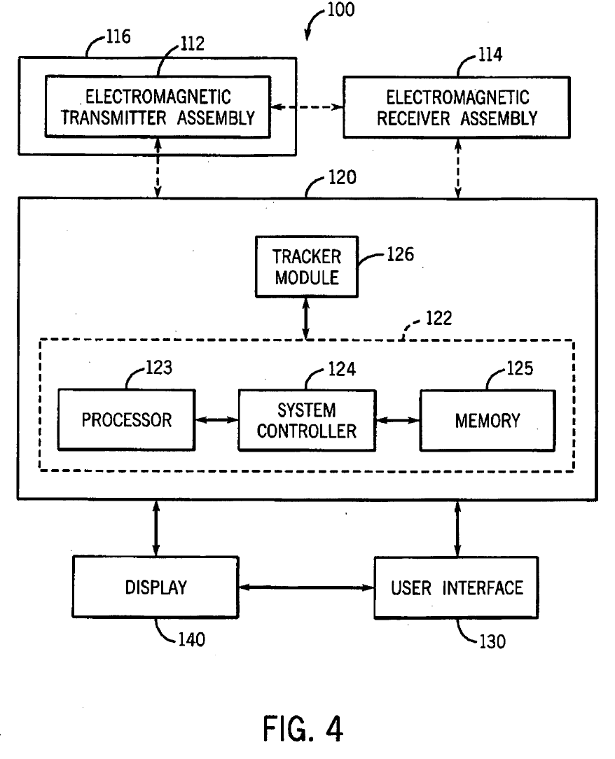

FIG. 4 is a block diagram illustrating an exemplary embodiment of a system for minimizing mutual inductance coupling between coils in an electromagnetic tracking system 100. The electromagnetic tracking system 100 comprises at least one electromagnetic transmitter assembly 112 with at least two coils and at least one electromagnetic receiver assembly 114 with at least one coil. The at least two coils of the at least one transmitter assembly may be referred to as coil 1, coil 2, up to coil N for N coils. The at least one electromagnetic transmitter assembly 112 may be mounted to a mounting fixture 116 to hold the at least one electromagnetic transmitter assembly 112 mechanically fixed relative to the at least one electromagnetic receiver assembly 114.

The electromagnetic tracking system 100 further comprises a tracker workstation 120 coupled to and receiving data from the at least one electromagnetic transmitter assembly 112 and the at least one electromagnetic receiver assembly 114, a user interface 130 coupled to the tracker workstation 120, and a display 140 for visualizing imaging and tracking data. The tracker workstation 120 includes a tracking system computer 122 and a tracker module 126. The tracking system computer 122 includes at least one processor 123, a system controller 124 and memory 125.

In an exemplary embodiment, the at least one electromagnetic transmitter assembly 112 may be a wireless transmitter assembly or a wired transmitter assembly. In an exemplary embodiment, the at least one electromagnetic receiver assembly 114 may be a wireless receiver assembly or a wired receiver assembly.

In an exemplary embodiment, the at least one electromagnetic transmitter assembly 112 may be attached to a medical device or instrument to be tracked and the at least one electromagnetic receiver assembly 114 may be positioned within the at least one electromagnetic field generated by the at least one electromagnetic transmitter assembly 112.

In an exemplary embodiment, the at least one electromagnetic receiver assembly 114 may be attached to a medical device or instrument to be tracked and the at least one electromagnetic transmitter assembly 112 may be positioned to generate at least one electromagnetic field receivable by the at least one electromagnetic receiver assembly 114.

In an exemplary embodiment, the tracker module 126 may include drive circuitry configured to provide a drive current to each coil of the at least one electromagnetic transmitter assembly 112. In an exemplary embodiment, the drive circuitry may be included on the at least one electromagnetic transmitter assembly 112. By way of example, a drive current may be supplied by the drive circuitry to energize a coil of the at least one electromagnetic transmitter assembly 112, and thereby generate an electromagnetic field that is detected by a coil of the at least one electromagnetic receiver assembly 114. The drive current may be comprised of a periodic waveform with a given frequency (e.g., a sine wave, cosine wave or other periodic signal). The drive current supplied to a coil will generate an electromagnetic field at the same frequency as the drive current. The electromagnetic field generated by a coil of the at least one electromagnetic transmitter assembly 112 induces a voltage indicative of the mutual inductance in a coil of the at least one electromagnetic receiver assembly 114. In an exemplary embodiment, the tracker module 126 may include receiver data acquisition circuitry for receiving voltage and mutual inductance data from the at least one electromagnetic receiver assembly 114. In an exemplary embodiment, the receiver data acquisition circuitry may be included on the at least one electromagnetic receiver assembly 114.

In an exemplary embodiment, the tracker module 126 may also include open circuit circuitry for each coil of the at least one electromagnetic transmitter assembly 112 capable of creating an open circuit for each coil to ensure no current flows through an open circuited coil over a specified period of time. In an exemplary embodiment, the open circuit circuitry for each coil may be included on the at least one electromagnetic transmitter assembly 112. In an exemplary embodiment, the open circuit circuitry may be a switch in series with each coil of the at least one electromagnetic transmitter assembly 112.

In an exemplary embodiment, the tracking system computer 122 may include at least one processor 123, such as a digital signal processor, a CPU, or the like. The processor 123 may process measured voltage and mutual inductance data from the at least one electromagnetic receiver assembly 114 to track the position and orientation of the at least one electromagnetic transmitter assembly 112 or the at least one electromagnetic receiver assembly 114.

The at least one processor 123 may implement any suitable algorithm(s) to use the measured voltage signal indicative of the mutual inductance to calculate the position and orientation of the at least one electromagnetic receiver assembly 114 relative to the at least one electromagnetic transmitter assembly 112, or the at least one electromagnetic transmitter assembly 112 relative to the at least one electromagnetic receiver assembly 114. For example, the at least one processor 123 may use ratios of mutual inductance between each coil of the at least one electromagnetic receiver assembly 114 and each coil of the at least one electromagnetic transmitter assembly 112 to triangulate the relative positions of the coils. The at least one processor 123 may then use these relative positions to calculate the position and orientation of the at least one electromagnetic transmitter assembly 112 or the at least one electromagnetic receiver assembly 114.

In an exemplary embodiment, the tracking system computer 122 may include a system controller 124. The system controller 124 may control operations of the electromagnetic tracking system 100.

In an exemplary embodiment, the tracking system computer 122 may include memory 125, which may be any processor-readable media that is accessible by the components of the tracker workstation 120. In an exemplary embodiment, the memory 125 may be either volatile or non-volatile media. In an exemplary embodiment, the memory 125 may be either removable or non-removable media. Examples of processor-readable media may include (by way of example and not limitation): RAM (Random Access Memory), ROM (Read Only Memory), registers, cache, flash memory, storage devices, memory sticks, floppy disks, hard drives, CD-ROM, DVD-ROM, network storage, and the like.

In an exemplary embodiment, the user interface 130 may include devices to facilitate the exchange of data and workflow between the system and the user. In an exemplary embodiment, the user interface 130 may include a keyboard, a mouse, a joystick, buttons, a touch screen display, or other devices providing user-selectable options, for example. In an exemplary embodiment, the user interface 130 may also include a printer or other peripheral devices.

In an exemplary embodiment, the display 140 may be used for visualizing the position and orientation of a tracked object with respect to a processed image from an imaging system.

Notwithstanding the description of the exemplary embodiment of the electromagnetic tracking system 100 illustrated FIG. 4, alternative system architectures may be substituted without departing from the scope of the invention.

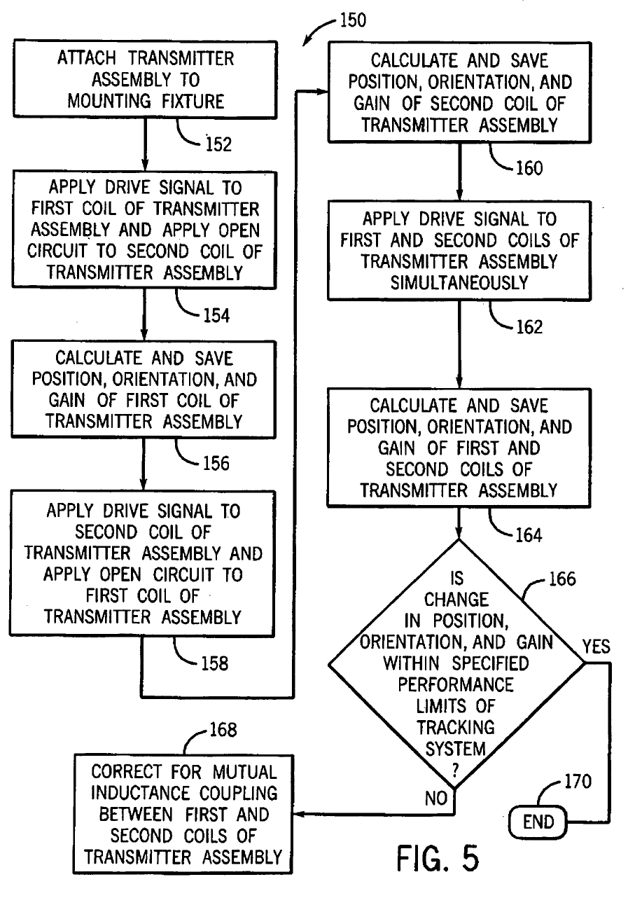

FIG. 5 is a flow diagram illustrating an exemplary embodiment of a method 150 of minimizing mutual inductance coupling between coils in an electromagnetic tracking system. The method 150 describes an exemplary embodiment for minimizing mutual inductance coupling between coils in an electromagnetic tracking system through a calibration process. This method 150 may be performed by one or more of the various components illustrated in FIG. 4. Furthermore, this method 150 may be performed in software, hardware, firmware, or any combination thereof.

The method 150 is used for calibrating a transmitter assembly of an electromagnetic tracking system. The method 150 may be implemented with a transmitter assembly having two or more coils in a Hazeltine arrangement and a receiver assembly. A Hazeltine arrangement is defined as two or more coils being separated from each other by a separation distance and being angled at approximately 54.7 degrees with respect to a horizontal axis extending through the centers of the two or more coils.

At step 152, the transmitter assembly is attached to a mounting fixture to hold the transmitter assembly in a mechanically fixed position relative to a receiver assembly. The transmitter assembly includes at least two coils. A drive signal from electronic drive circuitry is applied to a first coil to energize the first coil of the transmitter assembly and an open circuit signal is applied to a second coil of the transmitter assembly at step 154. The electromagnetic tracking system may include electronic drive circuitry for each coil of the transmitter assembly. The electronic drive circuitry is capable of energizing each coil to create an adequate magnetic field and enable each coil of the transmitter assembly to be tracked by the electromagnetic tracking system over a specified period of time. The electromagnetic tracking system may also include electronic open circuit circuitry for each coil of the transmitter assembly. The electronic open circuit circuitry is capable of creating an open circuit for each coil to ensure that no current flows through an open circuited coil over a specified period of time. Tracker electronics and a tracking algorithm may be used to calculate and save the position, orientation and gain of the first coil of the transmitter assembly at step 156. This provides baseline data on the first coil's position, orientation and gain in the absence of any mutual inductance coupling with the second coil.

At step 158, a drive signal from the electronic drive circuitry is applied to the second coil to energize the second coil of the transmitter assembly and an open circuit signal is applied to the first coil of the transmitter assembly. Tracker electronics and a tracking algorithm may be used to calculate and save the position, orientation and gain of the second coil of the transmitter assembly at step 160. This provides baseline data on the second coil's position, orientation and gain in the absence of any mutual inductance coupling with the first coil.

At step 162, a drive signal from the electronic drive circuitry is applied to the first and second coils to energize the first and second coils of the transmitter assembly simultaneously. The drive signal applied to the first and second coils of the transmitter assembly may be waveforms of different frequencies or different waveforms. It is assumed that the first and second coils are operating at different frequencies so that components of the induced signals in the coils of the receiver assembly from each coil of the transmitter assembly may be separated through signal processing techniques. Tracker electronics and a tracking algorithm may be used to re-calculate and save the position, orientation and gain of the first and second coils of the transmitter assembly at step 164.

At step 166, changes in position, orientation and gain of the first and second coils may be determined. Changes in the position, orientation and gain of both the first and second coils of the transmitter assembly may be due to the mutual inductance coupling between the first and second coils. If the change in position, orientation, and gain is within the specified performance limits of the electromagnetic tracking system, then the mutual inductance coupling between the first and second coils may be considered negligible, and the calibration process is finished at step 170. However, if the change in position, orientation, and gain is not within the specified performance limits of the electromagnetic tracking system, then the mutual inductance coupling between the first and second coils may be considered significant, and the mutual inductance coupling between the first and second coils of the transmitter assembly is corrected at step 168.

A couple of approaches may be used for correcting or compensating for the mutual inductance coupling between the first and second coils of the transmitter assembly. Tracker electronics and algorithms may be used to determine a coupling matrix or a coupling model for storing the effects of the measured mutual inductance coupling between the two coils of the transmitter assembly.

In a first approach, a coupling matrix between each coil of the transmitter assembly and the receiver assembly in the presence of a known and fixed distortion source is calculated. The coupling matrix represents the determined mutual inductance coupling between each coil of the transmitter assembly and the receiver assembly in the presence of a known and fixed distortion source. For the first coil of the transmitter assembly, the second coil is the known and fixed distorter and likewise, for the second coil of the transmitter assembly, the first coil is the known and fixed distorter. For mathematical simplicity the distorter may be modeled as a magnetic dipole element. For each coil, the gain of the distorter will be a fixed ratio of the particular transmitting coil's gain. The gain of the transmitting coil may vary over time, but as long as the distorter location and circuit impedance is constant, the gain ratio will be constant. The coupling matrix may be determined by iteratively adjusting the gain in the distorter until the position, orientation and gain measurements of the first coil alone and the second coil alone acceptably agrees with the position, orientation and gain measurements of both the first and second coils together. This ratio metric gain data and the spatial relationship information about the coils is saved and used during tracking.

In a second approach, a mutual inductance coupling model may be determined. The mutual inductance may be determined from the geometry and the known spatial relationship of the first and second coils of the transmitter assembly. Typically, the geometry of the coils (e.g., number of turns, turn size, ferrite core) is available from design specifications. From this information, the mutual inductance may be calculated (e.g., discrete double integral approximation) and that calculation may act as a good initial estimation of the mutual inductance. This estimation may be refined by adjusting the estimate of the mutual inductance until the position, orientation and gain measured in the single first coil or the single second coil energized states is achieved. Once a good estimate for mutual inductance is acquired, the mutual inductance estimate may be incorporated into the tracking algorithm and used during tracking.

The electromagnetic tracking system may now use the coupling matrix or coupling model to compensate for the characterized mutual inductance coupling between coils, and accurately track the position and orientation of a transmitter assembly or a receiver assembly that may be attached to a medical device, implant or instrument.

Several embodiments are described above with reference to drawings. These drawings illustrate certain details of exemplary embodiments that implement the systems, methods and computer programs of this disclosure. However, the drawings should not be construed as imposing any limitations associated with features shown in the drawings. This disclosure contemplates methods, systems and program products on any machine-readable media for accomplishing programmed operations. As noted above, certain embodiments may be implemented using an existing computer processor, or by a special purpose computer processor incorporated for this or another purpose, or by a hardwired system.

As noted above, certain embodiments within the scope of included program products comprise machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments described in the context of method steps may be implemented by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Certain embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the system might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

While the invention has been described with reference to various embodiments, those skilled in the art will appreciate that certain substitutions, alterations and omissions may be made to the embodiments without departing from the spirit of the invention. Accordingly, the foregoing description is meant to be exemplary only, and should not limit the scope of the disclosure as set forth in the following claims.

What is claimed is:

1. An electromagnetic tracking system comprising:
at least one transmitter assembly with at least two transmitter coils, the at least two transmitter coils spaced apart from each other and positioned to minimize the mutual inductance coupling between the at least two transmitter coils;
at least one receiver assembly with at least one receiver coil, the at least one receiver assembly communicating with and receiving signals from the at least two coils of the at least one transmitter assembly; and
electronics coupled to and communicating with the at least one transmitter assembly and the at least one receiver assembly for calculating the position and orientation of an object to be tracked.

2. The system of claim 1, wherein the at least two transmitter coils are angled at a fixed angle with respect to a longitudinal axis extending through centers of the at least two transmitter coils.

3. The system of claim 2, wherein the fixed angle is approximately 54.7 degrees.

4. The system of claim 1, wherein the at least one transmitter assembly is removably attachable to the object to be tracked.

5. The system of claim 4, wherein the object to be tracked is selected from the group consisting of a medical device, implant and instrument.

6. The system of claim 1, wherein the at least one receiver assembly is removably attachable to the object to be tracked.

7. The system of claim 6, wherein the object to be tracked is selected from the group consisting of a medical device, implant and instrument.

8. The system of claim 1, wherein each coil of the at least two transmitter coils is configured to emit a magnetic field when a drive signal is applied to each coil.

9. The system of claim 8, wherein each drive signal is a different waveform.

10. The system of claim 8, wherein each drive signal is a waveform with a different frequency.

11. The system of claim 1, wherein the at least one transmitter assembly is wireless.

12. The system of claim 1, wherein the at least one receiver assembly is wireless.

13. A method of minimizing mutual inductance coupling between coils in an electromagnetic tracking system, the method comprising:
arranging at least two coils of a transmitter assembly in a fixed arrangement, wherein the at least two coils are spaced apart from each other and angled at a fixed angle with respect to a longitudinal axis extending through the at least two coils;
applying a drive signal to each coil of the at least two coils of the transmitter assembly to generate a magnetic field from each coil;
tracking each coil of the at least two coils of the transmitter assembly independently as single coils with a receiver assembly and electronics for determining positions of the at least two coils; and
using the tracked positions and known fixed arrangement of the at least two coils for determining orientations of the at least two coils.

14. The method of claim 13, wherein the fixed angle is approximately 54.7 degrees.

15. The method of claim 13, wherein the drive signal applied to each coil is a different waveform.

16. The method of claim 13, wherein the drive signal applied to each coil is a waveform with a different frequency.

17. A system for minimizing mutual inductance coupling between coils in an electromagnetic tracking system, the system comprising:
at least one electromagnetic transmitter assembly with at least two coils, the at least two coils of the at least one transmitter assembly are spaced apart from each other and angled at a fixed angle with respect to a longitudinal axis extending through the at least two coils;
at least one electromagnetic receiver assembly with at least one coil;
drive circuitry for each coil of the at least two coils of the at least one electromagnetic transmitter assembly capable of providing a drive current to each coil for energizing each coil and having each coil generate a magnetic field that is detectable by at least one coil of the at least one electromagnetic receiver assembly; and
open circuit circuitry for each coil of the at least two coils of the at least one electromagnetic transmitter assembly capable of creating an open circuit for each coil and ensuring no current flows through an open circuited coil; and
electronics coupled to and communicating with the at least one transmitter assembly and the at least one receiver assembly for calculating the position and orientation of an object to be tracked;
wherein the at least one electromagnetic transmitter assembly is mounted to a mounting fixture to hold the at least one electromagnetic transmitter assembly mechanically fixed relative to the at least one electromagnetic receiver assembly.

18. The system of claim 17, wherein the fixed angle is approximately 54.7 degrees.

19. The system of claim 17, wherein the drive current is a periodic waveform with a given frequency.

20. The system of claim 17, wherein the at least one transmitter assembly is wireless.

21. The system of claim 17, wherein the at least one receiver assembly is wireless.

22. A method of improving the tracking of an electromagnetic tracking system, the method comprising:
calibrating a particular transmitter assembly comprising two or more single coils by determining the inherent mutual inductance coupling between the two or more single coils;
producing a mathematical representation of the inherent mutual inductance coupling between the two or more single coils of the particular transmitter assembly and storing the produced mathematical representation in association with that particular transmitter assembly;
tracking the position and orientation of the particular transmitter assembly; and
adjusting the tracked position and orientation of the particular transmitter assembly to compensate for any errors caused by the inherent mutual inductance coupling between the two or more single coils of the particular transmitter assembly.

23. The method of claim 22, wherein the step of producing the mathematical representation comprises modeling the inherent mutual inductance coupling between the two or more single coils of the particular transmitter assembly.

24. The method of claim 22, wherein the step of calibrating a particular transmitter assembly comprises:
tracking the position and orientation of each of the two or more single coils one at a time;
tracking the position and orientation of multiple single coils simultaneously; and
determining the inherent mutual inductance coupling between the two or more single coils based upon differences between the position and orientation of each coil when tracked alone and when tracked simultaneously with other coils.
